(19) United States
(12) Patent Application Publication
(10) Pub. No.: US 2015/0269454 A1
(43) Pub. Date: Sep. 24, 2015

(54) EXTRACTION DEVICE, METHOD, AND COMPUTER PROGRAM PRODUCT

(71) Applicant: KABUSHIKI KAISHA TOSHIBA, Tokyo (JP)

(72) Inventors: Asako Kanezaki, Kawasaki (JP); Satoshi Ito, Kawasaki (JP)

(21) Appl. No.: 14/656,849

(22) Filed: Mar. 13, 2015

(30) Foreign Application Priority Data
Mar. 20, 2014 (JP) 2014-058805

(51) Int. Cl. G06K 9/46; G06T 7/60

(52) U.S. Cl. CPC G06K 9/4604; G06T 7/60

(57) ABSTRACT

According to an embodiment, an extraction device includes an acquisition unit, a first calculator, a first extractor, and an output unit. The acquisition unit acquires point group data that are a set of points including three-dimensional coordinates on a surface of an object and normal vectors perpendicular to the surface of the object at the three-dimensional coordinates. The first calculator calculates, using the normal vectors of the respective points of the point group data, a normal space point density representing a density of points of the point group data in a normal space defined by axes that are parameters expressing the normal vectors. The first extractor extracts, from the point group data, one or more points at which the normal space point densities satisfy a predetermined condition of lowness. The output unit outputs the extracted one or more points.

### CROSS-REFERENCE TO RELATED APPLICATIONS

This application is based upon and claims the benefit of priority from Japanese Patent Application No. 2014-058805, filed on Mar. 20, 2014; the entire contents of which are incorporated herein by reference.

### FIELD

Embodiments described herein relate generally to an extraction device, a method therefor and a computer program product.

### BACKGROUND

For measuring a three-dimensional shape of an object, it is common to perform measurement multiple times since it is difficult to measure the entire object by one measurement. In this case, since point group data obtained by respective measurements have different coordinate systems, positioning is performed between the point group data to unify the coordinate systems of all the point group data and integrate all the point group data.

In a typical positioning method, multiple feature points are first extracted from one point group data, points corresponding to the respective extracted feature points are extracted from the other point group data, and positioning between the point group data is performed with rough accuracy on the basis of the correspondence between the respective extracted feature points and the respective extracted points corresponding thereto (hereinafter may also be referred to as a “first stage positioning”). Then, positioning between the respective points in one point group data and the respective points in the other point group data is performed with high accuracy (hereinafter may also be referred to as a “second stage positioning”). Note that the points in one point group data may be the points resulting from a process of thinning out the point group data, or the points in the other point group data may be the points resulting from a process of thinning out the other point group data.

Since positioning between the point group data is performed in stages, extraction of feature points from the point group data with high accuracy at the first stage positioning leads to positioning between the group point group data at higher speed.

Note that there is a technique of performing a thinning process so that many features points will remain from point group data to speed up the second stage positioning. With this technique, angles of the normal vectors of the respective points of the point group data are calculated, and the thinning process is performed on the point group data so that a partial point group whose distribution in the angle space is as large as possible will remain. In this manner, the thinning process is performed so that many points (feature points) will remain at corners having characteristic shapes of the object while few points (non-feature points) will remain on flat faces having non-characteristic shapes of the object.

Since, however, the technique of the related art as described above is not a technique of extracting feature points but is a technique of extracting and thinning non-feature points, a few non-feature points also remain in addition to feature points of the points resulting from the process of thinning the point group data. Thus, even if the technique of the related art as described above is applied to the first stage positioning, feature points cannot be extracted from the point group data with high accuracy.

### BRIEF DESCRIPTION OF THE DRAWINGS

FIG. 1 is a configuration diagram illustrating an example of an extraction device according to a first embodiment;

FIG. 2 is a drawing illustrating an example of an object according to the first embodiment;

FIG. 3 is a drawing illustrating an example of point group data at a part of the object according to the first embodiment;

FIG. 4 is a graph illustrating an example of a normal space according to the first embodiment;

FIG. 5 is a graph illustrating an example of normal space divided regions according to the first embodiment;

FIG. 6 is a diagram illustrating an example of extraction of points from the point group data according to the first embodiment;

FIG. 7 is a graph illustrating an example of a result of extraction of points in the normal space according to the first embodiment;

FIG. 8 is a drawing illustrating an example of a result of extraction of points at a part of the object according to the first embodiment;

FIG. 9 is a flowchart illustrating an example of overall processing according to the first embodiment;

FIG. 10 is a flowchart illustrating an example of an extraction process when the normal space point density is the number of points of the point group data contained in a normal space divided region according to the first embodiment;

FIG. 11 is a flowchart illustrating an example of a positioning process using the extraction device according to the first embodiment;

FIG. 12 is a configuration diagram illustrating an example of an extraction device according to a second embodiment;

FIG. 13 is a drawing illustrating an example of feature point group data at a part of an object extracted by a first extractor according to the second embodiment;

FIG. 14 is a graph illustrating an example of a position space according to the second embodiment;

FIG. 15 is a graph illustrating an example of position space divided regions according to the second embodiment;

FIG. 16 is a drawing illustrating an example of a result of extraction of points at a part of the object according to the second embodiment;

FIG. 17 is a flowchart illustrating an example of overall processing according to the second embodiment;

FIG. 18 is a configuration diagram illustrating an example of an extraction device according to a third embodiment;

FIG. 19 is a flowchart illustrating an example of overall processing according to the third embodiment; and

FIG. 20 is a block diagram illustrating a hardware configuration of the extraction device according to the embodiments.

### DETAILED DESCRIPTION

According to an embodiment, an extraction device includes an acquisition unit, a first calculator, a first extractor, and an output unit. The acquisition unit acquires point group data that are a set of points including three-dimensional coordinates on a surface of an object and normal vectors perpendicular to the surface of the object at the three-dimensional coordinates. The first calculator calculates, using the normal vectors of the respective points of the point group data, a normal space point density representing a density of points of the point group data in a normal space defined by axes that are parameters expressing the normal vectors. The first extractor extracts, from the point group data, one or more points at which the normal space point densities satisfy a predetermined condition of lowness. The output unit outputs the extracted one or more points.

Embodiments will be described below in detail with reference to the accompanying drawings.

### First Embodiment

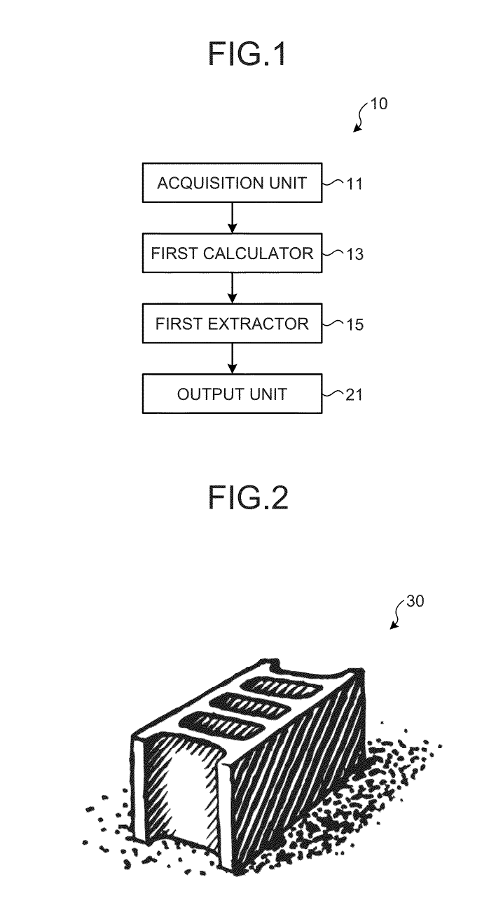

FIG. 1 is a configuration diagram illustrating an example of an extraction device 10 according to a first embodiment. As illustrated in FIG. 1, the extraction device 10 includes an acquisition unit 11, a first calculator 13, a first extractor 15, and an output unit 21. The acquisition unit 11, the first calculator 13, the first extractor 15, and the output unit 21 may be realized by causing a processing device such as a central processing unit (CPU) execute programs, that is, by software, may be realized by hardware such as integrated circuits (ICs), or may be realized by a combination of software and hardware.

The acquisition unit 11 acquires point group data that are a set of points including three-dimensional coordinates on a surface of an object, and normal vectors perpendicular to the surface of the object at the three-dimensional coordinates.

The three-dimensional coordinates are preferably three-dimensional position coordinates arranged in a three-dimensional Cartesian coordinate system, but are not limited thereto. The three-dimensional coordinates may be three-dimensional position coordinates arranged in a coordinate system that can be converted to a three-dimensional Cartesian coordinate system, such as three-dimensional position coordinates arranged in a three-dimensional polar coordinate system or a three-dimensional cylindrical coordinate system.

The normal vectors are preferably vectors each composed of three elements representing normal direction components on respective axes of a three-dimensional Cartesian coordinate system, but are not limited thereto. The normal vectors may be vectors arranged in a coordinate system that can be converted to a three-dimensional Cartesian coordinate system, such as vectors arranged in a three-dimensional polar coordinate system or a three-dimensional cylindrical coordinate system.

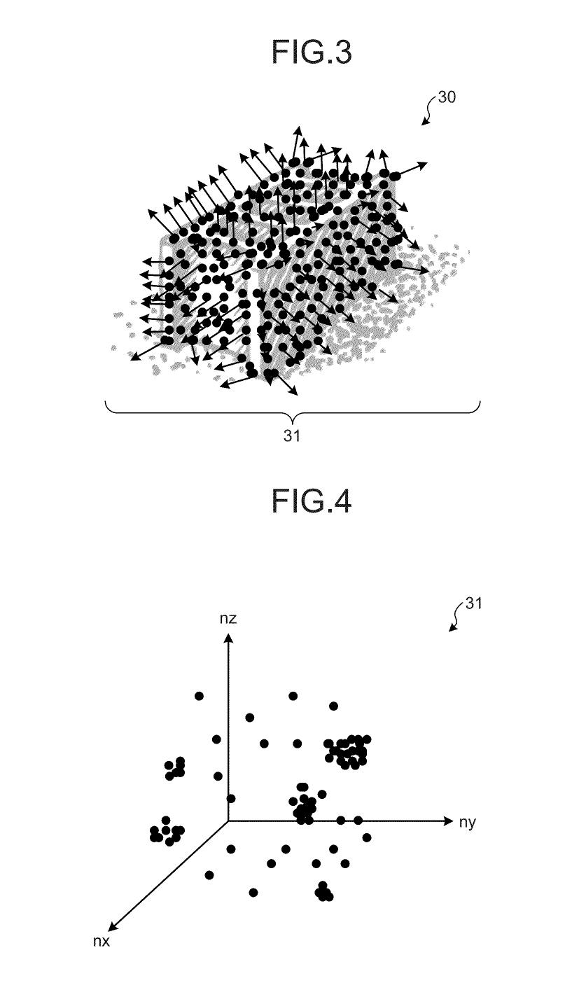

FIG. 2 is a drawing illustrating an example of an object 30 according to the first embodiment, and FIG. 3 is a drawing illustrating an example of point group data 31 at a part of the object 30 according to the first embodiment. In the examples illustrated in FIGS. 2 and 3, the acquisition unit 11 acquires the point group data 31 that are a set of points including three-dimensional coordinates on the surface of the object 30 and normal vectors perpendicular to the surface of the object 30 at the three-dimensional coordinates.

Note that the point group data acquired by the acquisition unit 11 may be generated through three-dimensional measurement using a laser sensor, a stereo camera, or the like, or may be generated by software such as 3D-DAD (computer aided design).

Furthermore, the points included in the point group data acquired by the acquisition unit 11 may include information other than the three-dimensional coordinates and the normal vectors. For example, if the point group data are generated through three-dimensional measurement using an active sensor, the point group data can further include reflection intensities at the respective points. Alternatively, for example, if the point group data are generated through three-dimensional measurement using a visible light camera, the point group data can further include luminance values at the respective points. Still alternatively, for example, if the point group data are generated through three-dimensional measurement using a color camera, the point group data can further include color information data at the respective points. Still alternatively, for example, if the point group data are generated through time-series three-dimensional measurement using a laser sensor, a stereo camera, and the like, the point group data can further include reliabilities at the respective points. Reliability represents the reliability that a point is actually present at the point. Still alternatively, for example, if the point group data are generated by 3D-CAD, the point group data can further include color information data, material information data, and the like at the respective points that are contained in 3D models.

The first calculator 13 uses the normal vectors of the respective points of the point group data acquired by the acquisition unit 11 to calculate a normal space point density representing the density of points of the point group data in a normal space defined by axes that are parameters expressing the normal vectors.

FIG. 4 is a graph illustrating an example of the normal space according to the first embodiment. In the example illustrated in FIG. 4, the first calculator 13 arranges the point group data 31 in the normal space by using the normal vectors of the respective points of the point group data 31. Specifically, since nx, ny, and nz that are axes of the normal space are three elements representing normal direction components, the first calculator 13 arranges the point group data 31 in the normal space on the basis of the parameters representing the normal vectors of the respective points of the point group data 31.

The normal space point density can be the number of points of the point group data contained in a normal space divided region obtained by dividing the normal space, for example. FIG. 5 is a graph illustrating an example of normal space divided regions according to the first embodiment. In the example illustrated in FIG. 5, the normal space divided regions are regions obtained by dividing the normal space expressed by a three-dimensional Cartesian coordinate system into a grid at equal intervals, but are not limited thereto. The first calculator 13 may calculate the number of points of the point group data contained in each of the normal space divided regions after voting (arranging) the respective points of the point group data 31 in the normal space (normal space divided regions). Alternatively, the first calculator 13 may vote weighted values that become smaller as the distances from the points increases in adjacent normal space divided regions instead of voting the points of the point group data only in corresponding normal space divided regions.

Note that the normal space point density is not limited thereto. For example, the normal space point density may be a value obtained by calculating, for each of the points of the point group data in the normal space, a function value that reduces as the distances between the point and adjacent points of the point group data which are at distances within a predetermined range from the point increase, and adding up the function values.

The function that reduces as the distance increases can be a normal distribution probability density, for example. In this case, the first calculator 13 can calculate the normal space point density by Expression (1).

$${\sum }_{i ∈ P} \frac{1}{\sqrt{2 π {σ}^{2}}} exp ( - \frac{{‖ {z}_{i} - z ‖}^{2}}{2 {σ}^{2}} ) \qquad ( 1 )$$

In the expression, z represents a normal vector of a point (target point) that is a target for calculating the normal space point density, P represents a set of adjacent points of a target point, zᵢ represents a normal vector of an i-th adjacent point, and σ² represents distribution of the point group data in the normal space but may be an appropriate constant.

The first calculator 13 may perform correction so that the normal space point density decreases as the deviation of the normal vector is larger. Note that the deviation of a normal vector represent a value that is larger for a normal vector in a direction in which the normal vector is easier to measure on an object.

Specifically, the deviation of a normal vector is caused depending on the method of division into the normal space divided regions and characteristics of measurement devices such as the laser sensor and the stereo camera for measuring the point group data.

As illustrated in FIG. 5, for example, assume that the normal space divided regions are regions obtained by dividing the normal space expressed by a three-dimensional Cartesian coordinate system into a grid at equal intervals. In this case, normal vectors are located on a sphere with a radius of 1. Thus, the deviation of a normal vector in each normal space divided region is larger as a region of the sphere that overlap with the normal space divided region is larger.

When the normal space point density in an i-th normal space divided region is represented by dᵢ and the surface area of a sphere having a radius of 1 contained in the normal space divided region is represented by Sᵢ, the first calculator 13 corrects the normal space point density by using Expression (2), for example.

$${d}_{i} ← \frac{{d}_{i}}{{S}_{i}} \qquad ( 2 )$$

As another example of correction, assume a case in which the measurement device is based on twin-lens stereovision or the like whose angular field of view is limited to a certain range.

In this case, a normal vector at an acute angle from the positive direction of the optical axis (the direction from an optical center toward the object) is not measured, and more normal vectors are measured as the angles from the positive direction of the optical axis are larger. Thus, the deviations of the normal vectors are large. The first calculator 13 may therefore perform correction so that the normal space point density greatly decreases as the angle from the positive direction of the optical axis is larger.

When the normal space point density at an i-th point is represented by dᵢ and the angle of the normal vector of the point from the positive direction of the optical axis is represented by Rᵢ, the first calculator 13 corrects the normal space point density by using Expression (3), for example.

$${d}_{i} ← \frac{{d}_{i}}{{R}_{i}} \qquad ( 3 )$$

Note that the first calculator 13 may combine a plurality of corrections to correct the normal space point density, and may apply both of Expressions (2) and (3), for example.

The first extractor 15 extracts one or more points at which the normal space point densities calculated by the first calculator 13 satisfy a predetermined condition of lowness as feature points from the point group data acquired by the acquisition unit 11. The first extractor 15 may extract a predetermined number of points in ascending order of the normal space point density or may extract points at which the normal space point densities are not larger than a threshold from the point group data.

When the normal space point density is the number of points of the point group data contained in a normal space divided region, the first extractor 15 calculates a value obtained by adding the numbers of points of the point group data contained in normal space divided regions in ascending order of the normal space point density, and extracts the points contained in normal space divided regions with which the added value is not larger than a predetermined value.

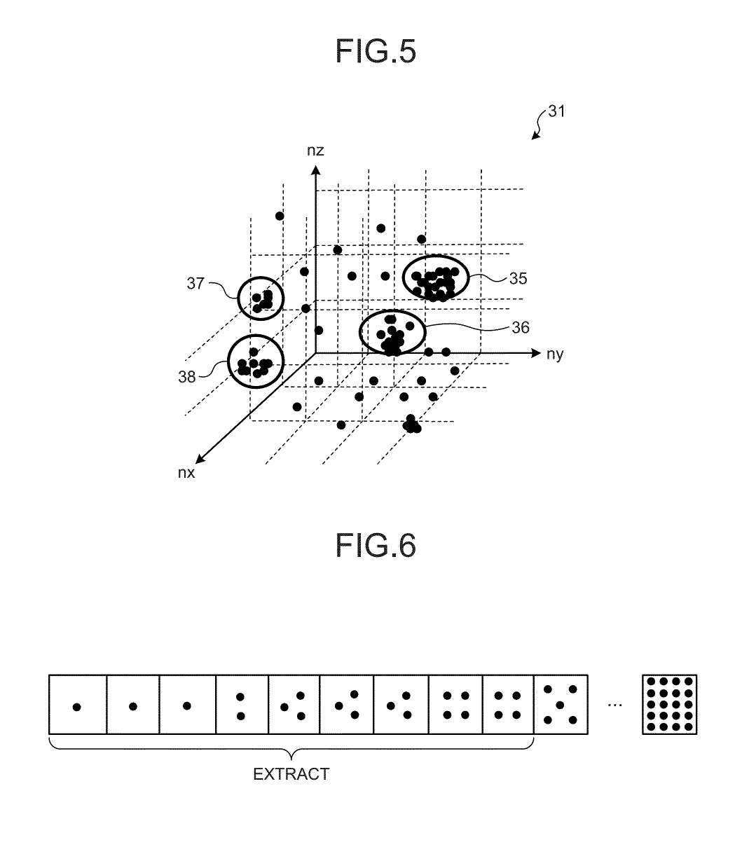

For example, as illustrated in FIG. 6, the first extractor 15 arranges the numbers of points of the point group data contained in the normal space divided regions in ascending order of the normal space point density, and calculates an added value obtained by adding normal space point densities (the numbers of points) in ascending order of the normal space point density. When the calculated added value reaches the threshold, the first extractor 15 then extracts the points contained in the normal space divided regions with which the added value is not larger than the predetermined number from the point group data. Since the predetermined number is 22 in the example illustrated in FIG. 6, for example, the first extractor 15 extracts the points contained in the normal space divided regions with which the added value is not larger than 22 (the points contained in the normal space divided regions where the numbers of points contained therein are 1 to 4) from the point group data when the calculated added value reaches 22.

Alternatively, in the example illustrated in FIG. 6, the threshold may be set to 4, and the first extractor 15 may extract the points contained in the normal space divided regions where the numbers of points of the point group data contained therein are 1 to 4 from the point group data.

When a normal space point density is a value calculated by Expression (1), the respective points of the point group data have normal space point densities, and thus a predetermined number of points may be extracted in ascending order of the value (normal space point density) or the points having the values (normal space point densities) that are nor larger than a threshold may be extracted.

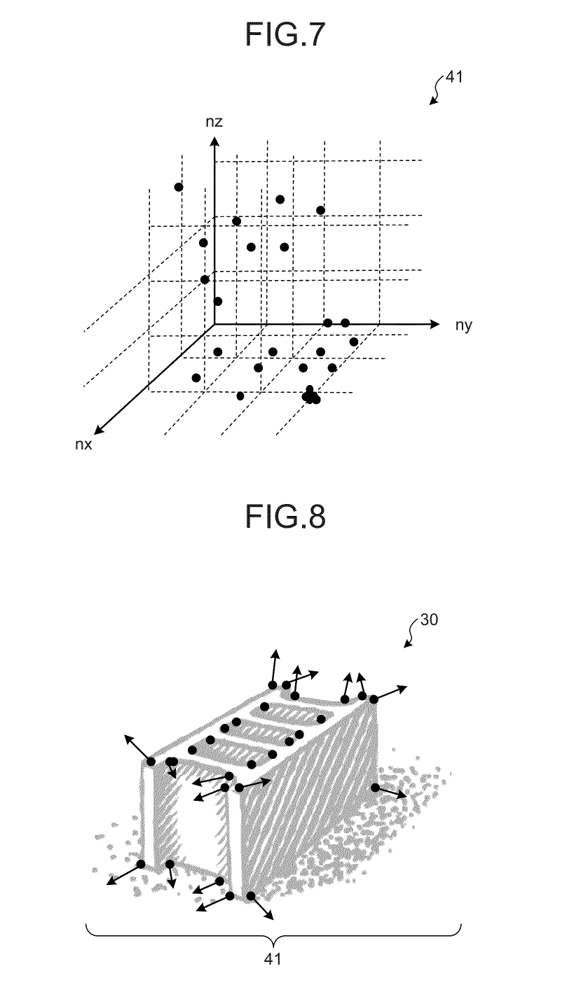

FIG. 7 is a graph illustrating an example of a result of extraction of the points in the normal space according to the first embodiment, and FIG. 8 is a drawing illustrating an example of a result of extraction of the points at a part of the object 30 according to the first embodiment. In the example illustrated in FIG. 7, a set (hereinafter may also referred to as (feature point group data 41″) of points that are points other than those represented by reference numerals 35 to 38 in the example illustrated in FIG. 5 is extracted. The points included in the feature point group data 41 are feature points present at corners or the like having characteristic shapes of the object 30 as illustrated in FIG. 8.

The output unit 21 outputs one or more points extracted by the first extractor 15.

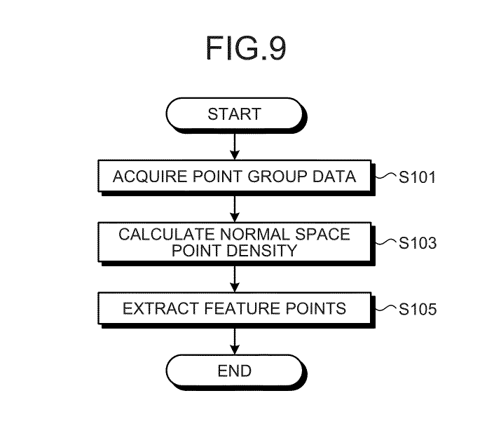

FIG. 9 is a flowchart illustrating an example of a flow of procedures of overall processing performed by the extraction device 10 according to the first embodiment.

First, the acquisition unit 11 acquires point group data (step S101).

Subsequently, the first calculator 13 uses the normal vectors of the respective points of the point group data acquired by the acquisition unit 11 to calculate the normal space point density in the normal space (step S103).

Subsequently, the first extractor 15 extracts one or more points at which the normal space point densities calculated by the first calculator 13 satisfy a predetermined condition of lowness as feature points from the point group data acquired by the acquisition unit 11 (step S105).

The output unit 21 then outputs the feature points extracted by the first extractor 15.

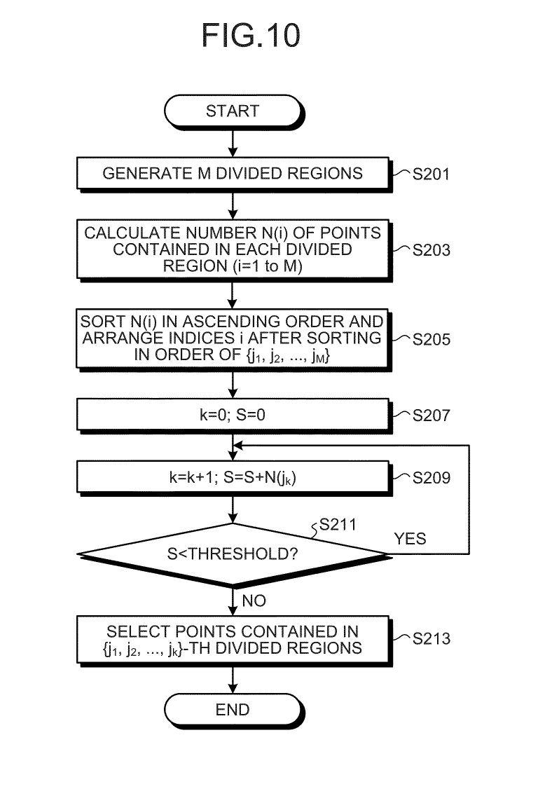

FIG. 10 is a flowchart illustrating an example of a flow of procedures of an extraction process when the normal space point density is the number of points of the point group data contained in a normal space divided region according to the first embodiment.

First, the first calculator 13 divides the normal space into M regions to generate M normal space divided regions (step S201).

Subsequently, the first calculator 13 calculates the number N(i) of points contained in each normal space divided region (step S203). Note that i=1 to M.

Subsequently, the first extractor 15 sorts N(i) in ascending order, and arranges the indices i resulting from sorting in the order of {j₁, j₂, . . . , j_{M}} (step S205).

Subsequently, the first extractor 15 initializes a variable k and a variable S to 0 (step S207).

Subsequently, the first extractor 15 increments k and adds the value of N(jₖ) to the variable S (initial value 0) (step S209).

Subsequently, the first extractor 15 checks whether or not the value of S is smaller than a predetermined number (step S211). If the value of S is smaller than the predetermined number (Yes in step S211), the process returns to step S209.

If the value of S is equal to or larger than the predetermined number (No in step S211), the first extractor 15 extracts the points contained in the {j₁, j₂, . . . , jₖ}-th divided regions (step S213).

As described above, according to the first embodiment, since points whose normal vector directions are scarce, that is, points with low normal space point densities are extracted as feature points, feature points can be extracted from point group data with high accuracy.

In general, points whose normal vector directions are scarce are feature points since the points are easily distinguished from nearby points while points whose normal vector directions are numerous are non-feature points since the points are not easily distinguished from nearby points. Note that the points whose normal vector directions are scarce are present at corners of a rectangular parallelepiped or surfaces having irregular shapes, and the points whose normal vector directions are numerous are likely to be present on flat surfaces. Thus, to extract feature points with high accuracy, it is necessary to extracts points whose normal vector directions are scarce by excluding points whose normal vector directions are numerous.

According to the first embodiment, since points whose normal vector directions are scarce, that is, points with low normal space point densities are extracted as feature points, it is possible to extract feature points by excluding non-feature points with high normal space point densities and extract feature points from point group data with high accuracy.

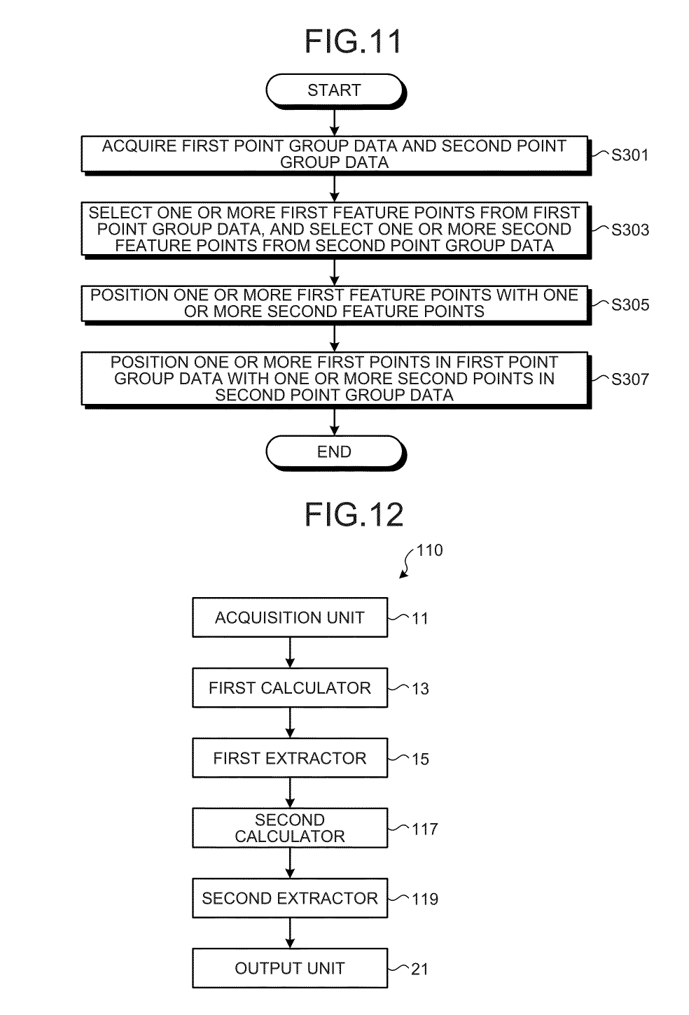

FIG. 11 is a flowchart illustrating an example of a positioning process using the extraction device 10 according to the first embodiment. While an example in which the processes other than extraction of feature points are also performed by the extraction device 10 is described herein, the processes other than extraction of feature points may be performed by devices other than the extraction device 10.

First, the extraction device 10 acquires first point group data and second point group data (step S301). Note that the first point group data and the second point group data are point group data obtained by measuring an object from different positions, for example.

Subsequently, the extraction device 10 extracts one or more first feature points from the first point group data, and extracts one or more second feature points from the second point group data (step S303). Herein, note that the respective one or more second feature points correspond to the respective one or more first feature points. Thus, the process of extracting feature points by the extraction device 10 described above is performed when one or more first feature points are extracted from the first point group data.

Subsequently, the extraction device 10 performs first stage positioning (positioning with rough accuracy) between the respective one or more first feature points and the respective one or more second feature points (step S305).

Subsequently, the extraction device 10 performs second stage positioning (positioning with high accuracy) between the respective one or more first points of the first point group data and the respective one or more second points of the second point group data (step S307).

Since the feature points can be extracted with high accuracy by applying the extraction process according to the first embodiment to extraction of feature points in positioning in this manner, the accuracy of the first stage positioning becomes higher and the second stage positioning can be sped up, which can also speed up the overall positioning between point group data.

### Second Embodiment

In a second embodiment, an example in which feature points are extracted so that non-feature points will not be included as noise. In the following, the difference from the first embodiment will be mainly described and components having similar functions as those in the first embodiment will be designated by the same names and reference numerals as those in the first embodiment, and the description thereof will not be repeated.

FIG. 12 is a configuration diagram illustrating an example of an extraction device 110 according to the second embodiment. As illustrated in FIG. 12, the extraction device 110 of the second embodiment is different from the first embodiment in a second calculator 117 and a second extractor 119.

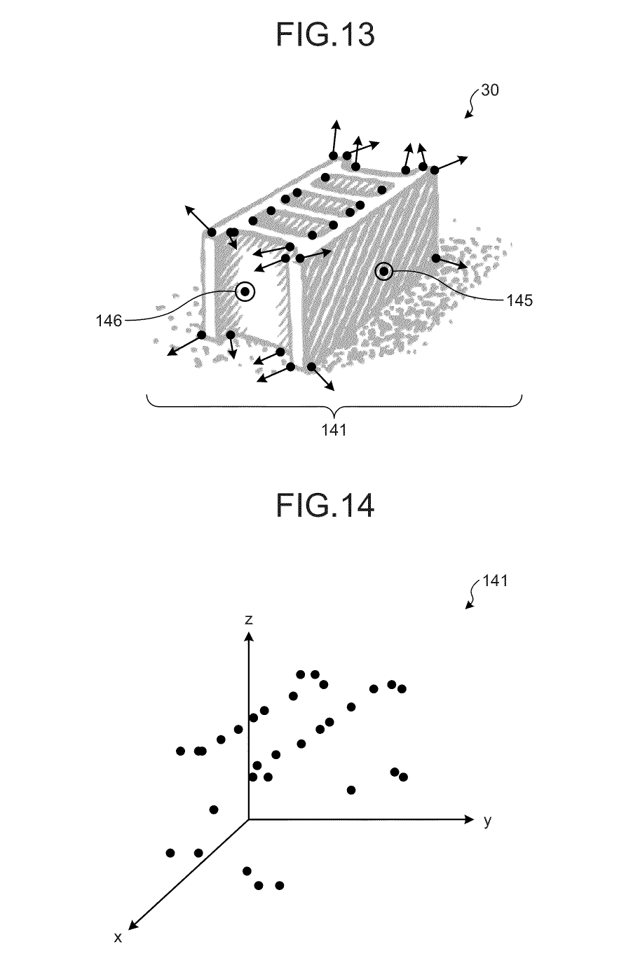

FIG. 13 is a drawing illustrating an example of feature point group data 141 at a part of an object 30 extracted by the first extractor 15 according to the second embodiment. In the example illustrated in FIG. 13, non-feature points 145 and 146 are included in feature point candidate group data 141 extracted by the first extractor 15 owing to the influence of noise or the like of the normal vectors. In the second embodiment, feature points are extracted from the feature point candidate group data 141 so that the non-feature points 145 and 146 will not be included.

The second calculator 117 uses three-dimensional coordinates of one or more points (herein after may also be referred to as “feature point candidate group data”) extracted by the first extractor 15 to calculate a position space point density representing the density of one or more points extracted by the first extractor 15 in a position space defined by axes that are parameters expressing the three-dimensional coordinates.

FIG. 14 is a graph illustrating an example of the position space according to the second embodiment. In the example illustrated in FIG. 14, the second calculator 117 arranges the feature point candidate group data 141 in the position space by using the three-dimensional coordinates of the respective points of the feature point candidate group data 141.

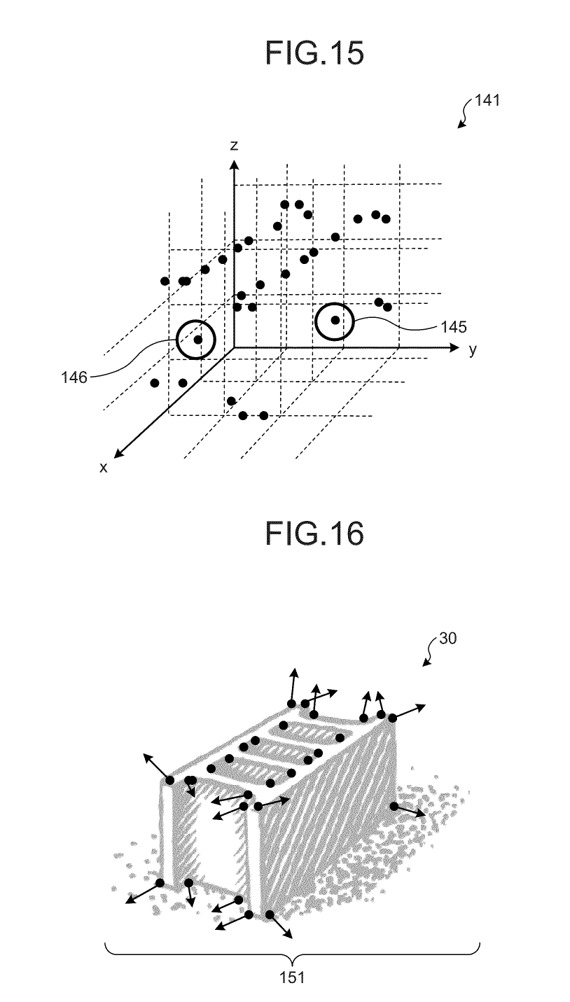

The position space point density can be the number of points of the feature point candidate group data contained in a position space divided region obtained by dividing the position space, for example. FIG. 15 is a graph illustrating an example of the position space divided regions according to the second embodiment. In the example illustrated in FIG. 15, the position space divided regions are regions obtained by dividing the position space expressed by a three-dimensional Cartesian coordinate system into a grid at equal intervals, but are not limited thereto. The second calculator 117 may calculate the number of points of the feature point candidate group data contained in each of the position space divided regions after voting (arranging) the respective points of the feature point candidate group data 141 in the position space (position space divided regions). Alternatively, the second calculator 117 may vote weighted values that become smaller as the distances from the points increases in adjacent position space divided regions instead of voting the points of the feature point candidate group data only in corresponding position space divided regions.

Note that the position space point density is not limited thereto. For example, the position space point density may be a value obtained by calculating, for each of the points of the feature point candidate group data in the position space, a function value that reduces as the distances between the point and adjacent points of the feature point candidate group data which are at distances within a predetermined range from the point increase, and adding up the function values.

The function that reduces as the distance increases can be a normal distribution probability density, for example. In this case, the second calculator 117 can calculate the position space point density by Expression (4).

$${\sum }_{i ∈ Q} \frac{1}{\sqrt{2 π {σ}^{′ 2}}} exp ( - \frac{{‖ {x}_{i} - x ‖}^{2}}{2 {σ}^{′ 2}} ) \qquad ( 4 )$$

In the expression, x represents three-dimensional coordinates of a point (target point) that is a target for calculating the position space point density, Q represents a set of adjacent points of the target point, xᵢ represents three-dimensional coordinates of an i-th adjacent point, and σ² represents distribution of the feature point candidate group data in the position space but may be an appropriate constant.

The second extractor 119 extracts one or more points at which the position space point densities exceed a threshold from the feature point candidate group data extracted by the first extractor 15.

FIG. 16 is a drawing illustrating an example of a result of extraction of points at a part of the object 30 according to the second embodiment. In the example illustrated in FIG. 16, a set (hereinafter may also be referred to as “feature point group data 151”) of one or more points other than the non-feature points 145 and 146 in the example illustrated in FIGS. 13 and 15. The points included in the feature point group data 151 are feature points present at corners or the like having characteristic shapes of the object 30 as illustrated in FIG. 16.

The output unit 21 outputs one or more points extracted by the second extractor 119.

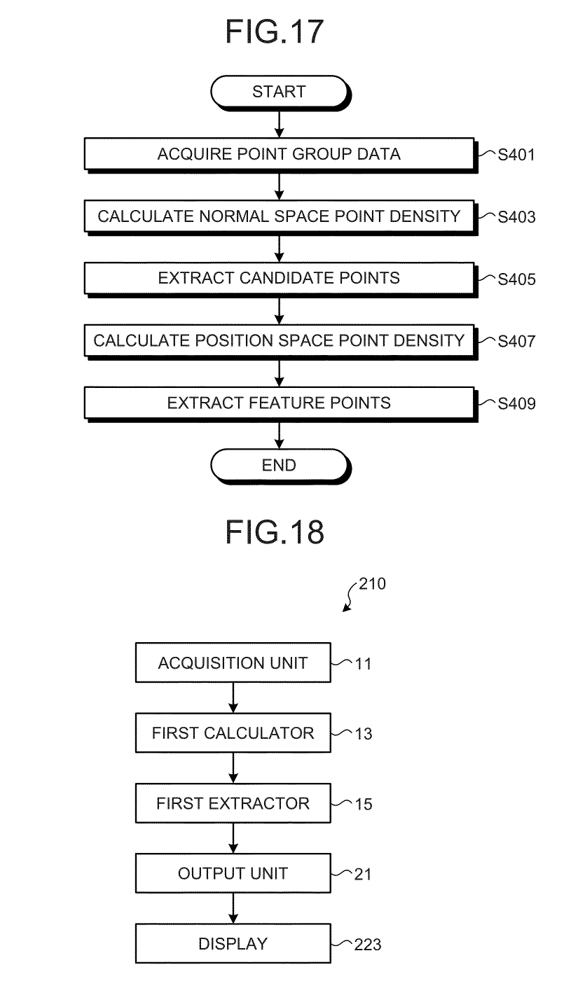

FIG. 17 is a flowchart illustrating an example of a flow of procedures of overall processing performed by the extraction device 110 according to the second embodiment.

First, the acquisition unit 11 acquires point group data (step S401).

Subsequently, the first calculator 13 uses the normal vectors of the respective points of the point group data acquired by the acquisition unit 11 to calculate the normal space point density in the normal space (step S403).

Subsequently, the first extractor 15 extracts one or more points at which the normal space point densities calculated by the first calculator 13 satisfy a predetermined condition of lowness as feature points from the point group data acquired by the acquisition unit 11 (step S405).

Subsequently, the second calculator 117 uses the three-dimensional coordinates of the feature point candidate group data extracted by the first extractor 15 to calculate the position space point density in the normal space (step S407).

Subsequently, the second extractor 119 extracts one or more points at which the position space point densities exceed a threshold as feature points from the feature point candidate group data extracted by the first extractor 15 (step S409).

The output unit 21 then outputs the feature points extracted by the second extractor 119.

In general, feature points on characteristic shapes tend to be located close to one another in a position space, but non-feature points generated owing to noise or the like of the normal vectors are sparsely present in a position space and are less likely to be close to one another.

In the second embodiment, since points whose normal vector directions are scarce, that is, points with low normal space point densities are extracted as candidate points, and points whose position space point densities exceed a threshold, that is, points that are not isolated in the position space are extracted as feature points, it is possible to extract feature points with high accuracy from point group data without including non-feature points erroneously calculated owing to noise or the like of the normal vectors.

### Third Embodiment

In a third embodiment, an example in which extracted feature points are output for display will be described. In the following, the difference from the first embodiment will be mainly described and components having similar functions as those in the first embodiment will be designated by the same names and reference numerals as those in the first embodiment, and the description thereof will not be repeated.

FIG. 18 is a configuration diagram illustrating an example of an extraction device 210 according to the third embodiment. As illustrated in FIG. 18, the extraction device 210 according to the third embodiment is different from the first embodiment in a display 223.

The display 223 can be realized by a display device such as a liquid crystal display, for example.

The output unit 21 outputs one or more points (feature point group data) extracted by the first extractor 15 to the display 223 for display. For the display by the display 223, an image or a moving image of 3D graphics in which the respective points of the feature point group data are arranged on three-dimensional coordinates of the points can be used. In this case, the display 223 may display the respective points of the feature point group data to be superimposed on the respective points of the point group data acquired by the acquisition unit 11, or may display the respective points with different colors or shapes so that the respective point groups can be distinguished from each other. Alternatively, the display 223 may display the feature point group data to be arranged on a two-dimensional image or moving image as viewed from a certain point of view without using 3D graphics.

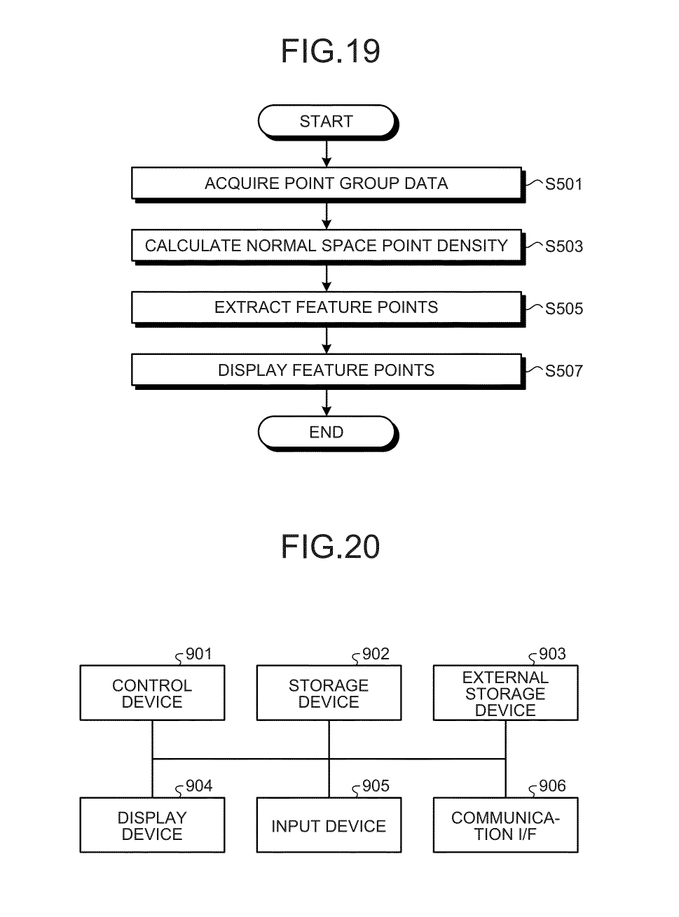

FIG. 19 is a flowchart illustrating an example of a flow of procedures of overall processing performed by the extraction device 210 according to the third embodiment.

First, the acquisition unit 11 acquires point group data (step S501).

Subsequently, the first calculator 13 uses the normal vectors of the respective points of the point group data acquired by the acquisition unit 11 to calculate the normal space point density in the normal space (step S503).

Subsequently, the first extractor 15 extracts one or more points at which the normal space point densities calculated by the first calculator 13 satisfy a predetermined condition of lowness as feature points from the point group data acquired by the acquisition unit 11 (step S505).

Subsequently, the output unit 21 outputs the feature points extracted by the first extractor 15 to the display 223 for display (step S507).

As described above, according to the third embodiment, a user can check whether or not the extracted points of the feature point group data are appropriate by visual observation. As a result, calculation of feature points allowing interactive adjustment of output results can be achieved.

Hardware Configuration

FIG. 20 is a block diagram illustrating an example of a hardware configuration of the extraction device according to the embodiments described above. As illustrated in FIG. 20, the extraction device according to the embodiments includes a control device 901 such as a CPU, a storage device 902 such as a ROM and a RAM, an external storage device 903 such as an HDD and an SSD, a display device 904 such as a display, an input device 905 such as a mouse and a keyboard, and a communication interface (I/F) 906, which can be realized by a hardware configuration using a common computer system.

Programs to be executed by the extraction device according to the embodiments are recorded on a computer readable recording medium such as a CD-ROM, a CD-R, a memory card, a DVD, and a flexible disk (FD) in a form of a file that can be installed or executed, and provided therefrom.

The programs to be executed by the extraction device according to the embodiments may be embedded in a ROM or the like in advance and provided therefrom. The programs to be executed by the extraction device according to the embodiments may be stored on a computer system connected to a network such as the Internet, and provided by being downloaded via the network. The programs to be executed by the extraction device according to the embodiments may be provided or distributed via a network such as the Internet.

The programs to be executed by the extraction device according to the embodiments may have a modular structure to realize the respective units described above on a computer system. In an actual hardware configuration, for example, the control device 901 reads the programs from the external storage device 903 onto the storage device 902 and executes the programs, whereby the respective units are realized on a computer system.

As described above, according to the embodiments described above, feature points can be extracted from point group data with high accuracy.

For example, the steps in the flowcharts in the embodiments described above may be carried out in a different order, some of the steps may be carried out simultaneously, or the order in which the steps are carried out may be changed each time the steps are carried out.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An extraction device comprising:
an acquisition unit to acquire point group data that are a set of points including three-dimensional coordinates on a surface of an object and normal vectors perpendicular to the surface of the object at the three-dimensional coordinates;
a first calculator to calculate, using the normal vectors of the respective points of the point group data, a normal space point density representing a density of points of the point group data in a normal space defined by axes that are parameters expressing the normal vectors;
a first extractor to extract, from the point group data, one or more points at which the normal space point densities satisfy a predetermined condition of lowness; and
an output unit to output the extracted one or more points.

2. The device according to claim 1, wherein the normal space point density is the number of points of the point group data contained in each of normal space divided regions obtained by dividing the normal space.

3. The device according to claim 1, wherein the normal space point density is a value obtained by calculating, for each of the points of the point group data in the normal space, a function value that reduces as distances between the point and adjacent points of the point group data which are at distances within a predetermined range from the point increase, and adding up the function values.

4. The device according to claim 1, wherein the first extractor extracts, from the point group data, a predetermined number of points in ascending order of the normal space point density.

5. The device according to claim 2, wherein the first extractor calculates a value obtained by adding the numbers of points of the point group data contained in normal space divided regions in ascending order of the normal space point density, and extracts, from the point group data, points contained in normal space divided regions with which the added value is not larger than a predetermined value.

6. The device according to claim 1, wherein the first extractor extracts, from the point group data, points at which the normal space point densities are not larger than a threshold.

7. The device according to claim 1, wherein the first calculator performs correction so that the normal space point density decreases as deviation of the normal vector is larger.

8. The device according to claim 1, further comprising:
a second calculator to calculates, using the three-dimensional coordinates of the one or more points, a position space point density representing a density of the one or more points in a position space defined by axes that are parameters expressing the three-dimensional coordinates; and
a second extractor to extract, from the one or more points, one or more points at which the position space point densities exceed a threshold, wherein
the output unit outputs the one or more points extracted by the second extractor.

9. The device according to claim 8, wherein the position space point density is the number of one or more points contained in each of position space divided regions obtained by dividing the position space.

10. The device according to claim 8, wherein the position space point density is a value obtained by calculating, for each of the one or more points in the position space, a function value that reduces as distances between the point and adjacent points of the one or more points which are at distances within a predetermined range from the point increase, and adding up the function values.

11. The device according to claim 1, wherein the output unit outputs the one or more points to a display and causes the display to display the one or more points.

12. An extraction method comprising:
acquiring point group data that are a set of points including three-dimensional coordinates on a surface of an object and normal vectors perpendicular to the surface of the object at the three-dimensional coordinates;
calculating, using the normal vectors of the respective points of the point group data, a normal space point density representing a density of points of the point group data in a normal space defined by axes that are parameters expressing the normal vectors;
extracting, from the point group data, one or more points at which the normal space point densities satisfy a predetermined condition of lowness; and
outputting the extracted one or more points.

13. A computer program product comprising a computer readable medium including programmed instructions, wherein the instructions, when executed by a computer, cause the computer to perform:
acquiring point group data that are a set of points including three-dimensional coordinates on a surface of an object and normal vectors perpendicular to the surface of the object at the three-dimensional coordinates;
calculating, using the normal vectors of the respective points of the point group data, a normal space point density representing a density of points of the point group data in a normal space defined by axes that are parameters expressing the normal vectors;
extracting, from the point group data, one or more points at which the normal space point densities satisfy a predetermined condition of lowness; and
outputting the extracted one or more points.
